(19) United States
(12) Patent Application Publication
(10) Pub. No.: US 2025/0350344 A1
(43) Pub. Date: Nov. 13, 2025

(54) TRACKING AREA UPDATE MANAGEMENT SYSTEMS AND METHOD FOR AERIAL USER EQUIPMENT OVER WIRELESS COMMUNCATION NETWORKS

(71) Applicant: AT&T Technical Services Company, Inc., Vienna, VA (US)

(72) Inventor: Daniel Vivanco, Ashburn, VA (US)

(21) Appl. No.: 18/659,103

(22) Filed: May 9, 2024

(51) Int. Cl. H04B 7/185; H04W 68/02

(52) U.S. Cl. CPC H04B 7/18502; H04W 68/02

(57) ABSTRACT

Aspects of the subject disclosure may include, for example, detecting that an operation state of an aerial user equipment (UE) is hovering in one or more tracking areas including a terrestrial tracking area and an aerial tracking area; detecting that a number of TAU messages, having sent to a network counterpart over a predetermined period of time, exceeds a first threshold count, where the TAU messages exceeding the first threshold count, represent a ping-pong condition between cells present at least in the terrestrial tracking area and the aerial tracking area; notifying the network counterpart of cell identifiers (cell IDs) of the cells in the ping-pong condition; forcing the aerial UE to enter into a TAU hold stage; and forcing the aerial UE not to transmit a TAU message during the TAU hold stage. Other embodiments are disclosed.

### FIELD OF THE DISCLOSURE

The subject disclosure relates to tracking area update management systems and methods for aerial user equipment in wireless communication networks.

### BACKGROUND

Applications for unmanned aerial vehicles (UAVs) are emerging and can provide a potential business area for mobile operators. Use cases of commercial UAVs are growing rapidly, including delivery, communications and media, inspection of critical infrastructure, surveillance, search-and-rescue operations, agriculture, etc. Research and development of current LTE mobile broadband communication has been primarily devoted to terrestrial communication. Providing tether-less broadband connectivity for unmanned aerial vehicles (UAVs) is an emerging field.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an aerial user equipment operating in a wireless communication network;

FIG. 2C depicts a tracking area cell ping-pong condition between a terrestrial tracking area and an aerial tracking area of an aerial user equipment;

FIG. 2D depicts an illustrative embodiment of transmission of tracking area update messages in accordance with various aspects described herein.

FIG. 2E depicts an illustrative embodiment of a method in accordance with various aspects described herein.

FIG. 2F depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for tracking area update (TAU) management systems and methods for aerial user equipment (UE) in wireless communication networks. The TAU management systems and methods prevent the aerial UE in an idle mode or a hovering state from transmitting tracking area update (TAU) messages as the TAU messages may result in a drainage of battery power or generating a large signaling overhead. Other embodiments are described in the subject disclosure.

One or more aspects of the subject disclosure are directed to a device including a processing system including a processor; and a memory that stores executable instructions that, when executed by the processing system, facilitate performance of operations. The operations include receiving, from an aerial user equipment (UE), a plurality of tracking area update (TAU) messages exceeding a threshold count of TAU messages set over a predetermined period of time, where the plurality of TAU messages exceeding the threshold count is indicative of an idle mode of the aerial UE, in the idle mode, the aerial UE is involved in a repeated cell reselection at least between a first tracking area and a second tracking area, the first tracking area having a cluster of terrestrial cells and the second tracking area having a cluster of aerial cells, and the aerial UE was registered to one of the cluster of aerial cells during an initial attachment; receiving, from the aerial UE, a notification of cell identifiers (cell IDs) of cells, among the cluster of terrestrial cells and the cluster of aerial cells, that have been associated with the aerial UE through the repeated cell reselection; and receiving no TAU message for a first extended period of time greater than the predetermined period of time.

One or more aspects of the subject disclosure are directed to a machine-readable medium, comprising executable instructions that, when executed by a processing system of an aerial user equipment including a processor, facilitate performance of operations. The operations comprises detecting that an operation state of an aerial user equipment (UE) is hovering in two or more tracking areas, where the two or more tracking areas comprise a terrestrial tracking area and an aerial tracking area; detecting that a number of TAU messages, having sent to a network counterpart over a predetermined period of time, exceeds a first threshold count, where the TAU messages exceeding the first threshold count, represent a ping-pong condition between cells present at least in the terrestrial tracking area and the aerial tracking area; notifying the network counterpart of cell identifiers (cell IDs) of the cells related to the ping-pong condition; forcing the aerial UE to enter into a TAU hold stage; and forcing the aerial UE to transmit no TAU message during the TAU hold stage.

One or more aspects of the subject disclosure are directed to a method including detecting, by a processing system of an unmanned aerial vehicle including a processor, that an operation state of the unmanned aerial vehicle (UAV) has entered into an idle mode; detecting, by the processing system, that a number of TAU messages, having sent to a network counterpart over a predetermined period of time, exceeds a first threshold count, wherein the TAU messages exceeding the first threshold count indicate a hovering condition of the UAV at least between a first tracking area and a second tracking area, the first tracking area having a cluster of terrestrial cells and the second tracking area having a cluster of aerial cells, and wherein the UAV was registered to one of the cluster of aerial cells during an initial attachment; notifying, by the processing system, the network counterpart of the detected idle mode of the UAV; transmitting, by the processing system, cell identifiers (cell IDs) of cells that the UAV has been connected in the hovering condition; activating, by the processing system, a TAU hold mode; and blocking, by the processing system, a TAU message from being sent to the network counterpart during the TAU hold stage.

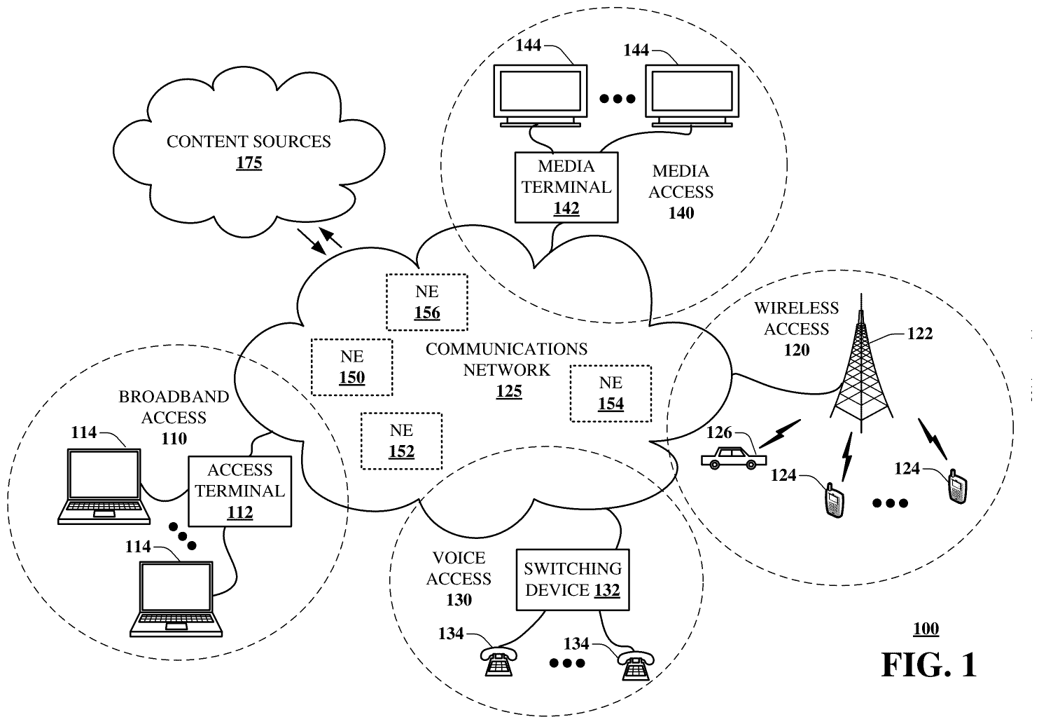

Referring now to FIG. 1, a block diagram is shown illustrating an example, non-limiting embodiment of a system 100 in accordance with various aspects described herein. For example, system 100 can facilitate in whole or in part tracking area update (TAU) management systems and methods for aerial user equipment in wireless communication networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

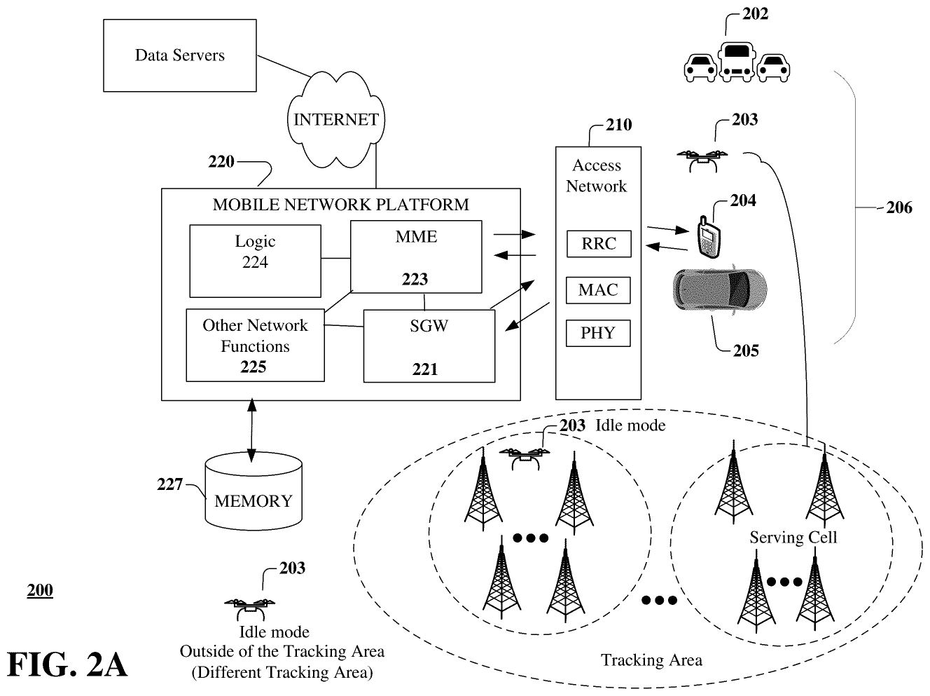

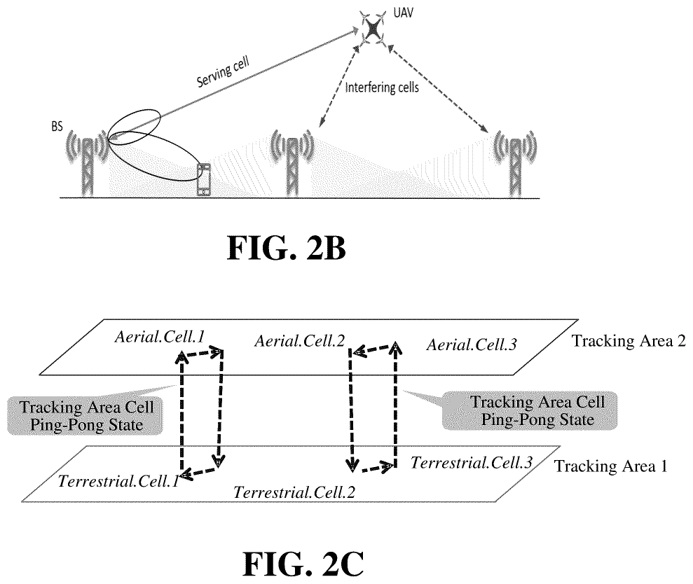

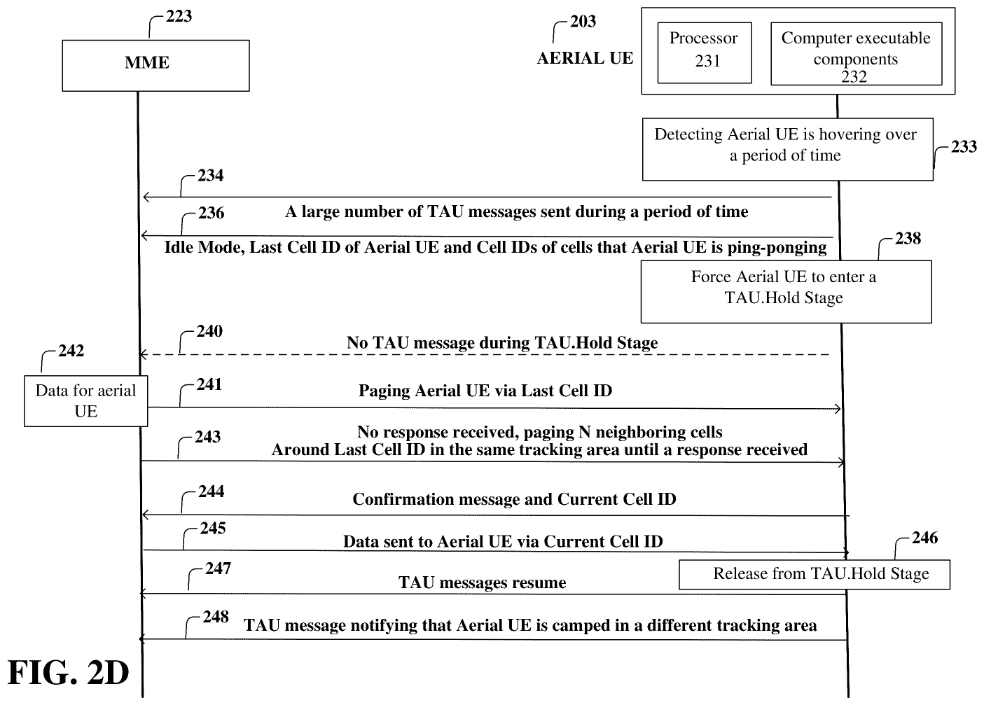

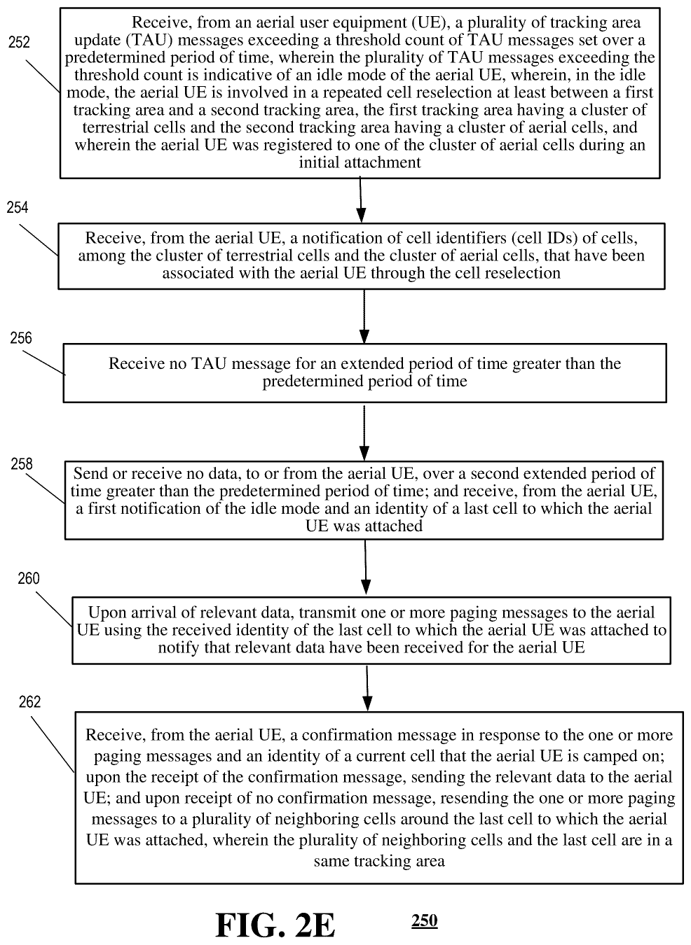

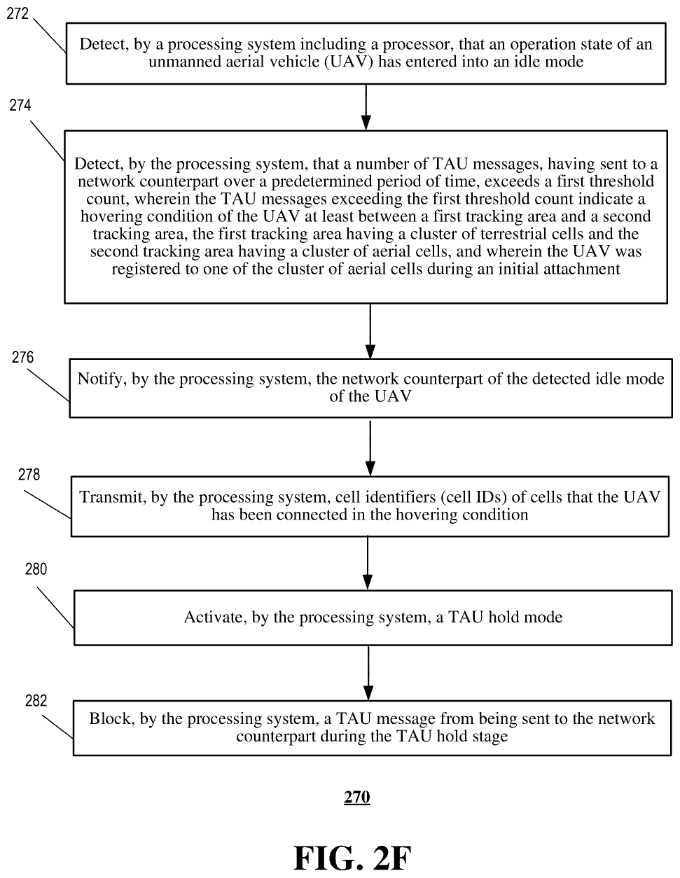

FIG. 2A is a block diagram illustrating an example, non-limiting embodiment of a tracking area management system (“the system”) 200 functioning within the communication network of FIG. 1 in accordance with various aspects described herein. The system 200 includes a plurality of different user equipment 202, 203, 204 and 205. The user equipment 202, 203, 204 and 205 are connected to an access network 210 which is connected to a mobile network platform 220. The user equipment 202, 203, 204 and 205 are connected to the internet via the access network 210 and the mobile network platform 220. The user equipment 202, 203, 204 and 205 (collectively, user equipment (UE) 206) have access to data servers via the internet.

In various embodiments, the mobile network platform 220 may include network devices and/or systems that provide a variety of functions. In certain embodiments, the mobile network platform 220 may be implemented in a cloud architecture. In some embodiments, the mobile network platform 220 implement LTE networks. In the LTE networks, examples of network functions provided by, or included, in the mobile network platform 220 include a Mobility Management Entity (MME) function 223, a Serving Gateway (SGW) 221 and other network functions 225 such as a Packet Data Network Gateway (PGW), Home Subscriber Server (HSS), etc. The MME 223 is responsible for an idle mode of user equipment (UE) by handling paging and tagging procedures. The MME 223 further handles selecting a serving gateway for a UE at an initial attachment and at the time of intra-LTE handover. The MME 223 is also involved with authentication of a user by interacting with the HSS and

FIG. 2A depicts that the mobile network platform 220 implements the LTE networks, but the present disclosure is not limited thereto. The mobile network platform 220 facilitates and support 5G, 6G, or any higher generation of cellular networks. Although not shown in the drawings, in the 5G networks, examples of functions provided by, or included, in the mobile network platform 220 include an access mobility function (AMF) configured to facilitate mobility management in a control plane of the network system (including, for instance, providing UE mobility information associated with the access network(s) 210 and/or the UE 206 to the mobile network platform 220), a user plane function (UPF) configured to provide access to a data network, such as a packet data network (PDN), in a user (or data) plane of the network system 200, a Unified Data Management (UDM) function, a Session Management Function (SMF), a policy control function (PCF), and/or the like. The mobile network platform 220 may be in communication with one or more other networks (e.g., one or more content delivery networks (CDNs)), one or more services, and/or one or more devices. In one or more embodiments, the mobile network platform 220 may include one or more devices implementing other functions, such as a master user database server device for network access management, a PDN gateway server device for facilitating access to a PDN, and/or the like. The mobile network platform 220 may include various physical/virtual resources, including server devices, virtual environments, databases, and so on.

In various embodiments, the access network 210 may include a wireless radio access network (RAN), a Wi-Fi network, and/or a wireline network. In exemplary embodiments, the access network 210 may be implemented in open source software (e.g., in an OpenAirInterface (OAI) wireless technology platform). The access network 210 may include network resources, such as one or more physical access resources and/or one or more virtual access resources. Physical access resources can include base station(s) (e.g., one or more NodeBs, one or more gNodeBs, or the like, such as base stations 206b), one or more satellites, one or more Gigabyte Passive Optical Networks (GPONs) or related components (e.g., Optical Line Terminal(s) (OLT), Optical Network Unit(s) (ONU), etc.), and/or the like. A base station may employ any suitable radio access technology (RAT), such as 4G/LTE, 5G, 6G, or any higher generation RAT.

One or more edge computing devices (e.g., multi-access edge computing (MEC) devices or the like) may also be included in or associated with the access network 210. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network 210 may include any number/types of physical/virtual access resources and various types of heterogeneous cell configurations with various quantities of cells and/or types of cells.

In certain embodiments, the access network 210 may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller. Here, base stations may be implemented as (e.g., passive) distributed radio elements connected to a centralized baseband processing pool. In some embodiments, the access network 210 may include, or communicate with, a RAN intelligent controller (RIC).

The system 200 can provide services to various types of UEs 202, 203, 204 and 205 (collectively, UE 206). Examples of UEs 206 include mobile devices 204, display and television devices, home and business networks, IoT devices, video and audio devices, autonomous vehicles 205, unmanned aerial vehicles (UAVs) 203, and so on. The UEs 206 may be equipped with one or more transmitter (Tx) devices and/or one or more receiver (Rx) devices configured to communicate with, and utilize network resources of, the system 200.

UAVs may include any (e.g., manually controllable or autonomous) personal or commercial aerial vehicle or device that is equipped with one or more types of devices or components for performing various actions. In certain embodiments, UAVs may include one or more radio equipment configured to function as a cellular relay (e.g., low-powered cellular radio access (or small cell) node(s)), one or more sensors (e.g., image sensor(s), infrared sensor(s), near infrared camera(s), radar system(s), light detection and ranging (LIDAR) system(s), biological sensor(s), temperature sensor(s), chemical sensor(s), humidity sensor(s), and/or the like) for capturing information/data in an environment of UAVs, one or more mechanical limbs for physically manipulating external objects, and/or the like. In some embodiments, one or more UAVs may be deployed to provide network connectivity for other UE(s). In certain embodiments, UAVs may provide network connectivity by way of wireless “tethering” to (e.g., a base station or the like of) an access network like the access network 210 or a different access network (i.e., one that is not experiencing a traffic surge condition) and/or via a wired link (e.g., over a fiber connection) to a network device (e.g., edge computing device or the like) that has a backhaul connection to the mobile network platform. UAVs may, additionally, or alternatively, communicate data (e.g., control data, user data, etc.) via the wireless tethering or wired link.

The 3rd Generation Partnership Project (3GPP) network groups has been researching the ability for aerial vehicles to be served using LTE network deployments with base station antennae targeting terrestrial coverage. This study item has been expected to be become a proposed feature set for 5G technologies. Many use cases of unmanned aerial vehicles (UAVs) require beyond visual line-of-sight (LOS) communications. Mobile networks offer wide area, high speed, and secure wireless connectivity, which can enhance control and safety of UAV operations and enable beyond visual LOS use cases. Existing LTE networks can support initial drone deployments. LTE evolution and 5G will provide more efficient connectivity for wide-scale drone deployments.

FIG. 2B depicts an aerial user equipment operating in a wireless communication network such as terrestrial LTE/5G networks. In some situations, wireless operators may add additional cells into a terrestrial wireless communication network to provide additional coverage to aerial UEs (e.g., UAVs). Terrestrial eNBs/gNBs may have down-tilted antennas to provide coverage to terrestrial UEs, while aerial eNB/gNBs may have antennas up-tilted to provide coverage aerial UEs. A group of cells are clustered in the same tracking area cells (TAC), operators may design the network to have a predefined number of cells in the same TAC (e.g., 100 cells). As more cells may be added in the same geographic area (e.g., a city) to serve aerial UEs, then a new TAC need to be also added to allow more cells into the same geographic area.

Aerial UEs (e.g., UAVs) may go to an idle mode. Sometimes, this means UAV may not send/receive data for a period of times. This may happen on the cases of autonomous vehicles (UAV or cars) that are not piloted by humans, by rather have enough intelligence to make driving decisions. Under these circumstances, UAV can enter the idle mode.

In some embodiments, because UEs already communicate different types of information to network administration processes at different times, to reduce the administrative overhead of implementing one or more embodiments, collected signal and location information can be added as a new part of an existing type of message, e.g., tracking area update message. To implement this ‘piggyback’ approach, UEs can be configured, e.g., by instruction instructing messaging component, to modify standard messages to further include additional information useful for one or more embodiments, e.g., UE global positioning system (GPS) location and ambient signal information.

An example general type of message that can be used by one or more embodiments described herein is an idle message, e.g., like the tracking area update (TAU) message, messages that can be generated by the UE during a time when the UE is not actively wirelessly communicating with the network in a call or exchanging mobile data. In one or more embodiments, idle messages can be generated based on a UE actively collecting information even though the UE is in an idle state. In one or more embodiments, for some idle messaging the collected information can be collected and stored before being used to generate an idle message.

Generally speaking, tracking area updates are messages sent by a UE to the network that can be used to inform the network when the UE, in an idle communication state, moves from one tracking area to another, e.g., often termed mobility messages because they can facilitate an idle UE being located by a paging message, even if it changes tracking areas while idle. In some implementations, a TAU message can also be generated and sent by a UE at a particular time interval, with this interval potentially being changed as described below by one or more embodiments.

TAU messages are an existing type of periodic message communicated by some user equipment. UEs already has procedures for composing tracking area update message, and sending the message out in certain circumstances. For example, during the regular generation and sending of an existing network administration message (e.g., tracking area update message), the information generated by one or more embodiments can be added to the existing message, e.g., with the use of existing unused data fields or by repurposing existing data fields.

When a UE detects that is has moved from one tracking area to another, the UE can subsequently transmit a tracking area update message by briefly transitioning out of the idle state of communications to receive the signals that can indicate the tracking area change and to communicate the update message to network administration processes. In addition, the idle state of communications can be used by the UE to reduce power consumption from communications processes but does not mean that the UE is not performing signal sampling and processing operations.

For these tracking area update message examples, it should be noted that, in many circumstances, a tracking area can refer to a collection of radio cells that can vary in size based on terrain and reception characteristics. Because of this, a tracking area can vary in size up to being hundreds of square kilometers, e.g., a tracking area update does not generally provide a granular indication of the location of a UE, as can be provided by global navigation satellite systems (GNSS). Thus, while unmodified tracking area update messages can be described as facilitating a tracking of location by controller equipment 150 within a broad area, this tracking is generally not sufficient to allocate antenna resources for the types of functions (e.g., accelerated connections to mode transitioning UEs) described with some embodiments herein. In some embodiments, a more precise location can be provided with an unmodified tracking area update message, e.g., with signal propagation data. Additionally, the more precise location can correspond with a level of precision used to the modified tracking area update message.

In addition to using instruction to modify an existing messaging procedure by adding (potentially unrelated) information to tracking area update messages, one or more embodiments can alter procedures (e.g., triggering events) for which the existing tracking area update messages are sent. For example, messages can be sent based on different events, e.g., based on a request, based on a change in signal strength, based on a change to a different tracking area, or at particular intervals.

For one or more embodiments, to facilitate achieving the goals of the newly generated and sent information, the triggering events for sending the tracking area update message can be changed. With respect to the tracking area update message triggering events, it should be noted that the conditions trigger generating and sending TAU messages, can be altered, e.g., to facilitate use of appended signal propagation data, for example, while preserving the original function of the altered message. For example, because the tracking area update message is triggered to be sent at a particular interval, the standard interval can be changed, e.g., reducing the interval to establish an increased granularity for the existing messaging because, for example, signal propagation data and GPS location data described herein, can be more useful if received more frequently by controller equipment. In one or more embodiments, the extra processing and battery overhead for the UE from the increased frequency of sending a tracking area update can be compared to the utility of the extra information provided for the approaches to network administration that can be provided by some embodiments.

FIG. 2C depicts a terrestrial tracking area and an aerial tracking area update of an aerial user equipment, In a given geographic area, a wireless operator may group terrestrial cells in the same tracking area, e.g., a first tracking area and group aerial cells in a different tracking area, e.g., a second tracking area, different from the first tracking area. At this time, an aerial UE in the idle mode moves through the network in an ascending and descending manner as shown in FIG. 2C, such as hovering. Then aerial UEs may trigger TAU message every time aerial UEs change tracking areas (i.e. from the first tracking area to the second tracking area and vice-versa). In certain situations, the aerial UEs such as UAVs may change tracking areas due to multiple reasons, such as altitude changes, traffic management policies, or UAVs being served by sidelobes pointing to a wrong direction.

As depicted in FIG. 2B, it is possible that some sidelobes of the terrestrial cells are pointing upwards, and therefore a UAV can detect their power. Therefore, the UAV may camp to the terrestrial cells even though the UAV are located at a higher altitude. The UAV may be hovering in place, and just change slightly its altitude, and by doing this, performing cell re-selection from a terrestrial cell to an aerial cell and vice-versa repeatedly. Under these circumstances, aerial UEs may trigger “ping pong” tracking area codes (TACs) between the terrestrial cells and the aerial cells. The UAV will then trigger multiple TAU messages every time the UAV transitions from one terrestrial cell to another aerial cell, as depicted in FIG. 2C. This may result in battery power drainage, as aerial UEs will have to transition from the idle mode to a connected mode in order to send a TAU message. Also, several consecutives TAU message can yield to a large signaling overhead.

FIG. 2D depicts an illustrative embodiment of transmission of TAU messages in accordance with various aspects described herein. In the system 200 depicted in FIG. 2A, the aerial UE 203 includes a processor 231 and computer executable components 232. The computer executable components 232, when executed by the processor 232, facilitate performance of operations. In various embodiments, the operations include detecting that the aerial UE 203 is hovering over a period of time (233). For instance, while the aerial UE 203 is hovering, there may be small variations of latitude, longitude, altitude or a combination thereof over a certain period of time. When the aerial UE 203 is hovering, small and continuous movements of up/down/shift can be detected. Such movement or operation states of the aerial UE 203 may indicate that the aerial UE 203 is hovering or may not be in an active mode. During the certain period of time, the aerial UE 203 may send a large number of tracking area update messages (234). This is because the aerial UE 203 may be in the state of moving between the terrestrial cells and the aerial cells, continuously and repeatedly changing tracking areas. Furthermore, in order to send TAU messages, the aerial UE 203 may need to transition from an idle mode to a connected mode. Accordingly, the aerial UE 203 may experience battery power drainage. The large number of TAU messages over a predetermined period of time can yield to a large signaling overhead.

In various embodiments, upon detection of the idle mode such as hovering, the aerial UE 203 notifies the MME 223 of the idle mode and a last cell ID to which the aerial UE 203 is attached (at 236). In addition, the aerial UE 203 sends to the MME 223 cell identifiers (cell IDs) of cells that the aerial UE 203 is ping-ponging, i.e., patterns of connected-disconnected-connected to different cells, etc. (at 236). Then, the operations further include forcing the aerial UE 203 to enter into a TAU.HOLD stage (238). During the TAU.HOLD stage, no TAU message is sent to the MME 223 (240). This is the case even when the aerial UE 203 is switched to different cells in different tracking areas. The aerial UE 203 is prevented or blocked from sending TAU messages to the MME 223 during the TAU.HOLD stage. By blocking TAU messages, the aerial UE 203 may preserve battery power and avoid generating a large signaling overhead.

In various embodiments, the operations further include releasing the TAU.HOLD stage upon determination that the aerial UE 203 is no longer hovering or in the idle mode (at 246). This determination can be made, for example, by detecting operation states of the aerial UE 203, such as moving through the network at a higher speed, continuous location changes, etc. As the aerial UE 203 moves, the aerial UE 203 resumes to send TAU messages and TAU messages will be sent to the MME 223 (at 247). Based on TAU messages by the aerial UE 203, the MME 223 can estimate a location of the aerial UE 203.

In various embodiments, the MME 223 is aware that the aerial UE 203 is in the TAU.HOLD stage. As one example, the MME 223 may determine the TAU.HOLD stage based on a plurality of cell IDs notified by the aerial UE 203 (at 236). As another example, the MME 223 may determine the TAU.HOLD stage based on a large number of TAU messages sent over a limited time from the aerial UE 203. The MME 223 may check periodically or aperiodically the TAU.HOLD stage, when UEs fall in the category of aerial UEs, in particular, autonomous UEs or unmanned UEs.

In various embodiments, the MME 223 may not determine or know a cell that the aerial UE 203 has camped on when the aerial UE 203 is in the idle mode. The aerial UE 203 transmits the last cell to which the aerial UE 203 was attached at the time of the idle mode together with the notification of the idle mode (236). Subsequently or later, when data arrives for the aerial UE 203 (at 242), the MME 223 is mandated to send paging to the aerial UE 203 via the last cell received from the aerial UE 203 in the idle mode notification (241). The aerial UE 203 sends a confirmation message to the paging and notifies the MME 223 of a current cell on which the aerial UE 203 is camped (at 244). Then the MME 223 sends the data to the aerial UE 203 via the current cell (at 245).

In various embodiments, when no response is received in response to the paging, the MME 223 then will send paging through a predetermined number (N) of neighboring cells around the last cell IDS that the aerial UE 203 has reported (at 243). The neighboring cells and the last cell are in the same tracking area. The paging may continue until a paging response is received from the aerial UE 203 (at 243 and 244). That way the MME 223 may identify the cell that the aerial UE 203 has camped on. Once the aerial UE 203 sends the confirmation message, the MME 223 sends data to aerial UE 203 via the current cell that the aerial UE has reported (at 245).

In certain embodiments, the aerial UE 203 has flown to a location that belongs to a different tracking area than an initial tracking area having the last cell. The aerial UE 203 sends a TAU message to the MME 223 to notify the MME 223 that the aerial UE is camped on a cell that belongs to the different tracking area (at 248).

FIG. 2E depicts an illustrative embodiment of a method 250 in accordance with various aspects described herein. In various embodiments, the method 250 includes receiving, from an aerial user equipment (UE), a plurality of track area update (TAU) messages exceeding a threshold count of TAU messages over a predetermined period of time, where the plurality of TAU messages exceeding the threshold count is indicative of an idle mode of the aerial UE (Step 252). In the idle mode, the aerial UE is involved in a repeated cell reselection at least between a first tracking area and a second tracking area, where the first tracking area has a cluster of terrestrial cells and the second tracking area has a cluster of aerial cells (Step 252). The aerial UE was registered to one of the cluster of aerial cells during an initial attachment (Step 252).

In various embodiments, the method 250 further includes receiving, from the aerial UE, a notification of cell identifiers (cell IDs) of cells, among the cluster of terrestrial cells and the cluster of aerial cells, that have been associated with the aerial UE through the cell reselection (Step 254). The method 250 further includes receiving no TAU message for an extended period of time greater than the predetermined period of time (Step 256).

In various embodiments, the method 250 further comprise sending or receiving no data, to or from the aerial UE, over a second extended period of time greater than the predetermined period of time (Step 258). The method 250 further includes, receiving a first notification of the idle mode from the aerial UE (Step 258). Subsequently or later, upon arrival of relevant data, the method 250 further includes transmitting one or more paging messages to the aerial UE using the received identity of the last cell to which the aerial UE was attached to notify that relevant data have been received for the aerial UE (Step 260).

In various embodiments, the method 250 further comprise receiving, from the aerial UE, a confirmation message in response to the one or more paging messages and an identity of a current cell that the aerial UE is camped on (Step 262). The method 250 also includes, upon the receipt of the confirmation message, sending the relevant data to the aerial UE, and upon receipt of no confirmation message, resending the one or more paging messages to a plurality of neighboring cells around the last cell to which the aerial UE was attached (Step 262). The plurality of neighboring cells and the last cell are in a same tracking area (Step 262).

In various embodiments, the method 250 further includes receiving, from the aerial UE, a tracking area update message identifying a current cell in a different tracking area on which the aerial UE is camped. When the aerial UE has moved to the different tracking area during the idle mode, the aerial UE sends a TAU message to update the current serving cell information rather than responding to the paging messages and sending the confirmation message which apply to the cell change in the same tracking area during the idle mode.

In various embodiments, the method 250 further comprise, upon the receiving of no TAU message for the extended period of time, determining that the aerial UE has entered into a TAU hold stage. In various embodiments, the method 250 further comprise receiving an identifier of the aerial UE and determining that the aerial UE is an autonomous aerial vehicle. The method 250 further comprise, subsequent to a passage of the extended period of time, receiving a series of TAU messages from the aerial UE and estimating a location of the aerial UE based on the received series of TAU messages.

FIG. 2F depicts an illustrative embodiment of another method 270 in accordance with various aspects described herein. In various embodiments, the method 270 includes detecting, by a processing system of an unmanned aerial vehicle including a processor, that an operation state of the unmanned aerial vehicle (UAV) has entered into an idle mode (Step 272). For instance, the operation state of the UAV may be hovering based on detection of variations of latitude, longitude, altitude or a combination thereof of the aerial UE, by a predetermined degree smaller than a preset threshold degree. As another example, the UAV may experience ping-pong conditions between cells in different tracking areas, such as the UAV being switched to the terrestrial tracking area from the aerial tracking area and switched back to the terrestrial tracking area.

The method 270 further includes detecting, by the processing system, that a number of TAU messages, having sent to a network counterpart over a predetermined period of time, exceeds a first threshold count (Step 274). The TAU messages exceeding the first threshold count indicate a hovering condition of the UAV at least between a first tracking area and a second tracking area, and the first tracking area has a cluster of terrestrial cells and the second tracking area has a cluster of aerial cells (Step 274). The UAV may have been registered to one of the cluster of aerial cells during an initial attachment (Step 274). The method 270 further include, notifying, by the processing system, the network counterpart of the detected idle mode of the UAV (Step 276) and transmitting, by the processing system, cell identifiers (cell IDs) of cells that the UAV has been connected in the hovering condition (Step 278). The method 270 includes activating, by the processing system, a TAU hold mode (Step 280) and blocking, by the processing system, a TAU message from being sent to the network counterpart during the TAU hold stage (Step 282). The blocking the TAU message (Step 282) further comprises transmitting no TAU message when the UAV is attached to a different cell during the TAU hold stage. The method 270 includes forcing the UAV to transmit no TAU message even when the aerial UE is attached to a different cell during the TAU hold stage.

In various embodiments, the method 270 further comprise, upon detection that the operation state of the aerial UE is no longer hovering, releasing the aerial UE from the TAU hold stage. The method 270 further includes deactivating, by the processing system, the TAU hold mode by detecting a termination of the idle mode of the UAV. The detecting the termination of the idle mode of the UAV further comprises detecting a moving speed of the UAV, a change of location information of the UAV, or a variation of latitude, longitude or altitude of the UAV or a combination thereof, to be greater than a second threshold degree. Additionally, the detecting that the operation state of the UAV has entered into the idle mode, such as hovering, further comprises detecting variations of latitude, longitude, altitude or a combination thereof of the aerial UE, by a predetermined degree smaller than the second threshold degree. The method 270 further includes, subsequent to the deactivation of the TAU hold mode, resuming to transmit, by the processing system, a series of TAU messages to the network counterpart, wherein the series of TAU messages facilitate estimating a location of the UAV by the network counterpart.

In various embodiments, the method 270 further includes detecting that the operation state of the UAV has entered into an idle mode; sending, to the network counterpart, a first notification of the idle mode and an identity of a last cell to which the UAV was attached at the time that the UAV has entered into the idle mode; receiving, from the network counterpart, a paging message via the last cell to which the UAV was attached; and sending, to the network counterpart, a confirmation message to the paging message and an identity of a first current cell where the UAV is camped, when the first current cell and the last cell are in a same tracking area; or sending, to the network counterpart, a TAU message identifying a second current cell in a different tracking area and to which the UAV is currently attached.

While for purposes of simplicity of explanation, the respective processes are shown and described as a series of blocks in FIGS. 2E and 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the above described embodiments, the TAU management systems and methods detect that an aerial UE is in a hovering stage and that it is engaged in TAC ping-pong. The TAU management systems and methods take action to hold corresponding TAU messages, but at the same time can estimate the location of the aerial UE such as an UAV in case a paging message needs to be sent to the aerial UE.

In the above described embodiments, algorithms included and implemented in the aerial UE, in form of computer executable instructions, detect that the aerial UE is hovering, i.e. by determining small variations of latitude/longitude/altitude over a period of time. The algorithms also determine that a large number of TAU (between aerial TAC and terrestrial TAC) messages have been sent during that period of time. The algorithms then notify the large number of TAU messages to its counterpart (e.g., the MME at the mobile network platform) and provides Cell.IDs of the cells that the aerial UE is ping-ponging. The algorithms then force the aerial UE to enter a TAU.HOLD stage. During this stage, the aerial UE cannot send TAU messages to the network counterpart, even though the aerial UE is switched to different TACs. By doing this, the algorithms prevent the aerial UE (e.g., the UAV) from draining a battery power and engaging into a large signaling overhead. The algorithms can get the aerial UE out of the TAU.HOLD stage upon determination that the aerial UE is not hovering anymore, such as if the aerial UE is moving through the network.

In the above described embodiments, algorithms in form of computer executable instructions at the network counterpart of the aerial UE, such as at the MME, are aware that the aerial UE is in the TAU.HOLD mode. However, the MME may not know a cell that the aerial UE has camped on. The algorithms at the MME will use the Cell.IDs of the cells that the aerial UE has reported. If data arrives for this aerial UE, the algorithms at the MME will mandate the MME to send paging through all the Cell.IDs of the cells that the aerial UE has reported. If the MME does not receive a paging response from the aerial UE in a first try, then the algorithms at the MME will mandate the MME to send paging though “N” neighboring cells around the Cell. IDs of the cells that the aerial UE has reported. For instance, “N” can be configured to designate a number of neighboring cells based on a network environment. This process will continue until a paging response is received from the aerial UE.

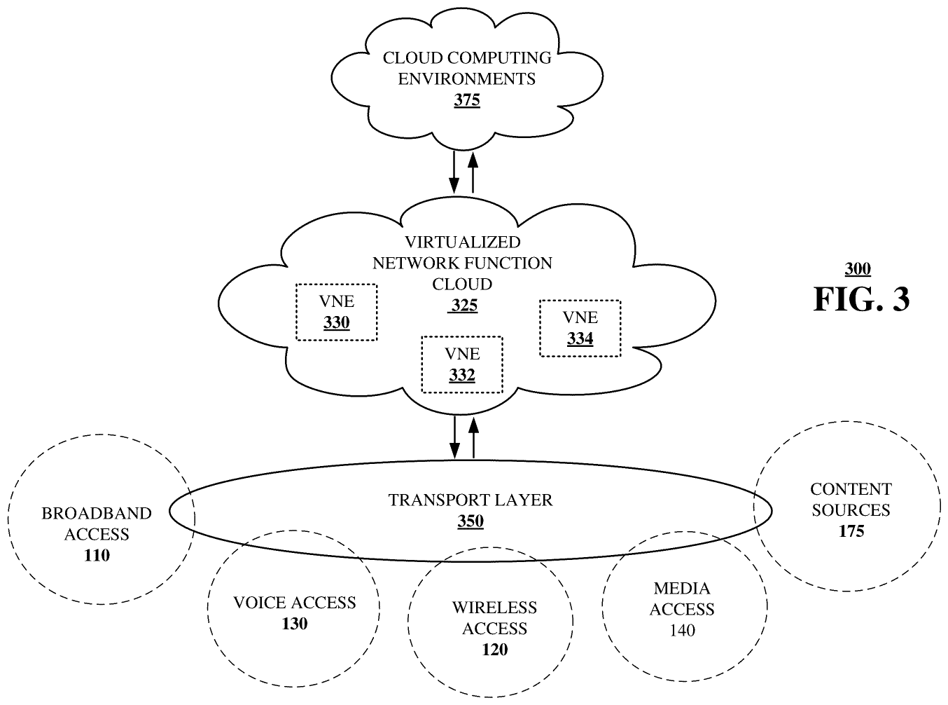

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part tracking area update (TAU) management systems and methods for aerial user equipment in wireless communication networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure casier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

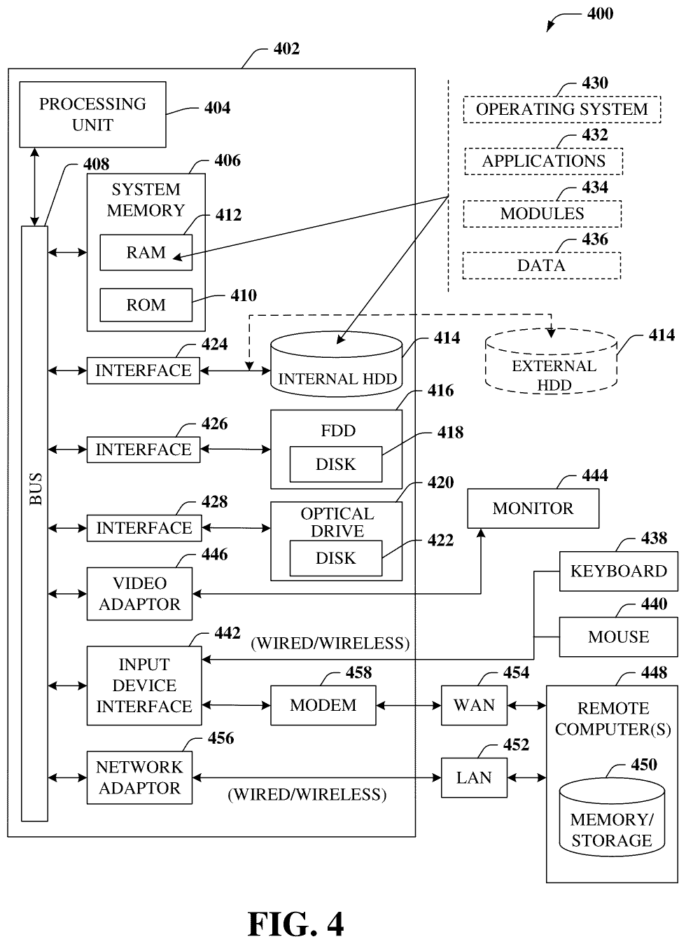

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part tracking area update (TAU) management systems and methods for aerial user equipment in wireless communication networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

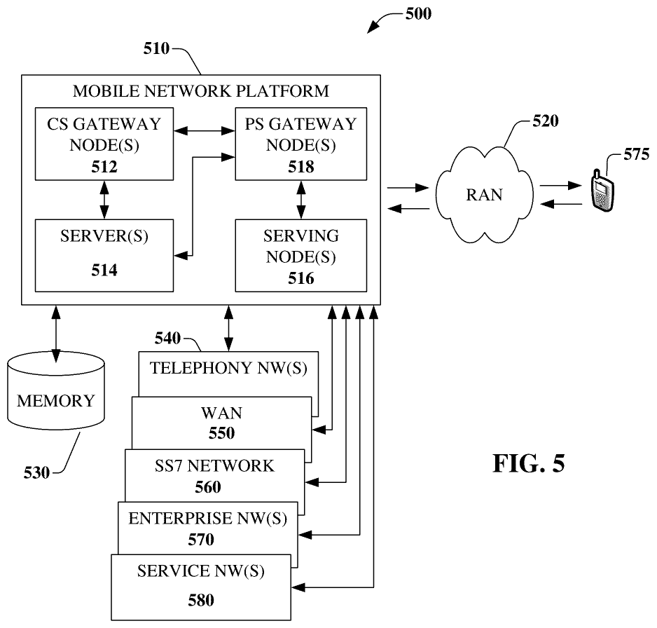

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part tracking area update (TAU) management systems and methods for aerial user equipment in wireless communication networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

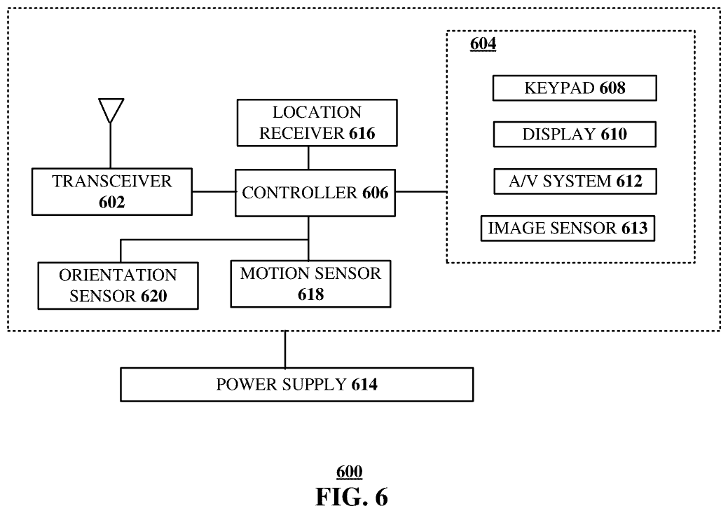

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part <tie to a few of the main features of the claims>.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

One or more of the embodiments described herein can be combined in whole or in part with the embodiments described in co-pending U.S. Patent Application Ser. No.______(having Attorney Docket No. 2022-1216_7785-3176A), entitled “TRACKING AREA UPDATE SYSTEMS AND METHODS FOR AERIAL USER EQUIPMENT IN WIRELESS COMMUNICATION NETWORKS,” filed on even date herewith. For instance, embodiments of the aforementioned U.S. application can be combined in whole or in part with embodiments of the subject disclosure. For example, one or more features and/or embodiments described in the aforementioned U.S. application can be used in conjunction with (or as a substitute for) one or more features and/or embodiments described herein, and vice versa. Accordingly, all sections of the aforementioned U.S. application are incorporated herein by reference in their entirety.

What is claimed is:

1. A device, comprising:
a processing system including a processor; and
a memory that stores executable instructions that, when executed by the processing system, facilitate performance of operations, the operations comprising:
receiving, from an aerial user equipment (UE), a plurality of tracking area update (TAU) messages exceeding a threshold count of TAU messages set over a predetermined period of time, wherein the plurality of TAU messages exceeding the threshold count is indicative of an idle mode of the aerial UE,
wherein, in the idle mode, the aerial UE is involved in a repeated cell reselection at least between a first tracking area and a second tracking area, the first tracking area having a cluster of terrestrial cells and the second tracking area having a cluster of aerial cells, and wherein the aerial UE was registered to one of the cluster of aerial cells during an initial attachment,
receiving, from the aerial UE, a notification of cell identifiers (cell IDs) of cells, among the cluster of terrestrial cells and the cluster of aerial cells, that have been associated with the aerial UE through the repeated cell reselection; and
receiving no TAU message for a first extended period of time greater than the predetermined period of time.

2. The device of claim 1, wherein the operations further comprise:
sending or receiving no data, to or from the aerial UE, over a second extended period of time greater than the predetermined period of time; and
receiving, from the aerial UE, a first notification of the idle mode and an identity of a last cell to which the aerial UE was attached.

3. The device of claim 2, wherein the operations further comprise:
upon arrival of relevant data, transmitting one or more paging messages to the aerial UE using the received identity of the last cell to which the aerial UE was attached to notify that the relevant data have been received for the aerial UE.

4. The device of claim 3, wherein the operations further comprise:
receiving, from the aerial UE, a confirmation message in response to the one or more paging messages and an identity of a current cell that the aerial UE is camped on;
upon the receipt of the confirmation message, sending the relevant data to the aerial UE; and
upon receipt of no confirmation message, resending the one or more paging messages to a plurality of neighboring cells around the last cell to which the aerial UE was attached, wherein the plurality of neighboring cells and the last cell are in a same tracking area.

5. The device of claim 1, wherein the operations further comprise:
sending or receiving no data to or from the aerial UE over a second extended period of time greater than the predetermined period of time; and
receiving, from the aerial UE, a tracking area update message identifying a current cell in a different tracking area on which the aerial UE is camped.

6. The device of claim 1, wherein the operations further comprise receiving from the aerial UE, a second notification the aerial UE has entered into a TAU hold stage.

7. The device of claim 1, wherein the operations further comprise:
receiving an identifier of the aerial UE; and
determining that the aerial UE is an autonomous aerial vehicle.

8. The device of claim 1, wherein the operations further comprise:
subsequent to a passage of the second extended period of time, receiving a series of TAU messages from the aerial UE; and
estimating a location of the aerial UE based on the received series of TAU messages.

9. A non-transitory, machine-readable medium, comprising executable instructions that, when executed by a processing system of an aerial user equipment including a processor, facilitate performance of operations, the operations comprising:
detecting that an operation state of an aerial user equipment (UE) is hovering in two or more tracking areas, wherein the two or more tracking areas comprise a terrestrial tracking area and an aerial tracking area;
detecting that a number of TAU messages, having sent to a network counterpart over a predetermined period of time, exceeds a first threshold count, wherein the TAU messages exceeding the first threshold count, represent a ping-pong condition between cells present at least in the terrestrial tracking area and the aerial tracking area;
notifying the network counterpart of cell identifiers (cell IDs) of the cells related to the ping-pong condition;
forcing the aerial UE to enter into a TAU hold stage; and
forcing the aerial UE to transmit no TAU message during the TAU hold stage.

10. The machine-readable medium of claim 9, wherein the operations further comprise, upon detection that the operation state of the aerial UE is no longer hovering, releasing the aerial UE from the TAU hold stage.

11. The machine-readable medium of claim 9, wherein then forcing the aerial UE to transmit no TAU message further comprises transmitting no TAU message when the aerial UE is attached to a different cell during the TAU hold stage.

12. The machine-readable medium of claim 9, wherein the detecting that the operation state of the aerial UE is hovering further comprises detecting variations of latitude, longitude, altitude or a combination thereof of the aerial UE, by a predetermined degree smaller than a second threshold degree.

13. The machine-readable medium of claim 9, wherein the operations further comprise:
detecting that the operation state of the aerial UE has entered into an idle mode;
sending, to the network counterpart, a first notification of the idle mode and an identity of a last cell to which the aerial UE was attached at the time that the aerial UE has entered into the idle mode;
receiving, from the network counterpart, a paging message via the last cell to which the aerial UE was attached; and
sending, to the network counterpart, a confirmation message to the paging message and an identity of a first current cell where the aerial UE is camped, when the first current cell and the last cell are in a same tracking area; or
sending, to the network counterpart, a TAU message identifying a second current cell in a different tracking area and to which the aerial UE is currently attached.

14. The machine-readable medium of claim 9, wherein, in the ping-pong condition between cells, the aerial UE is switched to the terrestrial tracking area from the aerial tracking area and switched back to the terrestrial tracking area.

15. A method, comprising:
detecting, by a processing system of an unmanned aerial vehicle including a processor, that an operation state of the unmanned aerial vehicle (UAV) has entered into an idle mode;
detecting, by the processing system, that a number of TAU messages, having sent to a network counterpart over a predetermined period of time, exceeds a first threshold count, wherein the TAU messages exceeding the first threshold count indicate a hovering condition of the UAV at least between a first tracking area and a second tracking area, the first tracking area having a cluster of terrestrial cells and the second tracking area having a cluster of aerial cells, and wherein the UAV was registered to one of the cluster of aerial cells during an initial attachment;
notifying, by the processing system, the network counterpart of the detected idle mode of the UAV;
transmitting, by the processing system, cell identifiers (cell IDs) of cells that the UAV has been connected in the hovering condition;
activating, by the processing system, a TAU hold mode; and
blocking, by the processing system, a TAU message from being sent to the network counterpart during the TAU hold stage.

16. The method of claim 15, further comprising:
sending, to the network counterpart, an identity of a last cell to which the UAV was attached at the time that the UAV has entered into the idle mode;
receiving, from the network counterpart, a paging message via the last cell to which the UAV was attached, wherein the paging message is configured to notify the UAV of arrival of relevant data; and
sending, to the network counterpart, a confirmation message in response to the paging message and an identity of a current cell where the UAV is camped, wherein the current cell and the last cell are in a same tracking area.

17. The method of claim 15, further comprising:
sending, to the network counterpart, an identity of a last cell to which the UAV was attached at the time that the UAV has entered into the idle mode;
receiving, from the network counterpart, a paging message via the last cell to which the UAV was attached; and
sending, to the network counterpart, a TAU message identifying a current cell where the UAV is camped and that belongs to a different tracking area from a tracking area of the last cell.

18. The method of claim 15, further comprising deactivating, by the processing system, the TAU hold mode by detecting a termination of the idle mode of the UAV.

19. The method of claim 18, wherein the detecting the termination of the idle mode of the UAV further comprises detecting a moving speed of the UAV, a change of location information of the UAV, or a variation of latitude, longitude or altitude of the UAV or a combination thereof, to be greater than a second threshold degree.

20. The method of claim 18, further comprising:
subsequent to the deactivation of the TAU hold mode, resuming to transmit, by the processing system, a series of TAU messages to the network counterpart, wherein the series of TAU messages facilitate estimating a location of the UAV by the network counterpart.
